(19) United States
(12) Patent Application Publication
(10) Pub. No.: US 2012/0080968 A1
(43) Pub. Date: Apr. 5, 2012

(54) MAGNETIC BRAKE FOR MOTOR

(76) Inventors: Steven J. Knight, Mission Hill, SD (US); James Edward Elsen, Yankton, SD (US)

(21) Appl. No.: 13/248,884

(22) Filed: Sep. 29, 2011

Related U.S. Application Data
(60) Provisional application No. 61/388,726, filed on Oct. 1, 2010.

(51) Int. Cl. H02K 7/10

(52) U.S. Cl. 310/76; 310/77

(57) ABSTRACT

A magnetic braking motor system including a motor and a magnetic brake assembly. The motor includes a motor enclosure and a motor shaft rotatably mounted with respect to the motor enclosure. The magnetic brake assembly includes a rotating magnetic element and a stationary magnetic element. The rotating magnetic element is mounted with respect to the motor shaft. The stationary magnetic element is mounted with respect to the motor enclosure. A magnetic field is provided between the rotating magnetic element and the stationary magnetic element.

### REFERENCE TO RELATED APPLICATION

This application claims priority to U.S. Provisional Application Number 61/388,726, which was filed on Oct. 1, 2010, the contents of which are incorporated herein by reference.

### FIELD OF THE INVENTION

The invention relates generally to braking systems for motors. More particularly, the invention relates a magnetic brake for a motor.

### BACKGROUND OF THE INVENTION

It is relatively common to transport bulk products such as grain and sand utilizing open top vehicles because the upwardly directed opening enables the bulk product to be quickly deposited into the vehicle.

A drawback of the open top vehicle is that the product may fall out of the open top vehicle as the open top vehicle moves. For example, the wind may blow the product out of the open top vehicle. This process is undesirable because the product that blows out of the open top vehicle not only reduces the amount of product that is delivered, but also potentially causes damage to other vehicles that are proximate the open top vehicle when contacted by product falling out of the open top vehicle.

In response to this situation, cover systems have been developed. These cover systems are typically movable between an open configuration and a closed configuration. When the cover system is in the open configuration, a substantial portion of the open top vehicle is not covered so that the product may be placed into the open top vehicle. When the cover system is in the closed configuration, a substantial portion of the open top vehicle is covered to prevent product in the open top vehicle from falling out of the open top vehicle.

Examples of the open top vehicle covers are disclosed in Sibley, U.S. Pat. No. 3,546,197; Sibley, U.S. Pat. No. 3,549,199; Sibley, U.S. Pat. No. 3,628,826; Bachand et al., U.S. Pat. No. 3,868,142; Peteratti, U.S. Pat. No. 4,082,347; Peteratti, U.S. Pat. No. 4,126,351; and Compton, U.S. Pat. No. 4,516,802 and Dimmer, U.S. Patent No. RE31746.

While it is possible for the cover systems to be manually operated such as with a hand crank, it is also possible for the cover systems to be operated using a motor that is operably connected to the cover system. Examples of motorized cover systems are disclosed in Schmeichel, U.S. Pat. Nos. 7,188,887 and 7,195,304.

An end portion of a prior art motorized cover system is illustrated in FIG. 1. This figure illustrates an end of a trailer 10 to which the motorized cover system 12 is attached. While the end is typically a front end, a person of skill in the art would appreciate that the cover system could be attached with the motor on the front or back ends of the trailer.

The motorized cover system 12 generally includes a motor assembly 20, a shaft 22 and a tarp portion 24. The motor assembly 20 is operably attached to the shaft 22 to cause the tarp 24 to be rolled to an open configuration or unrolled to a closed configuration.

The motor assembly 20 is operably mounted with respect to the trailer 10 using an arm assembly 26. In certain configurations, the arm assembly 26 includes at least two arm sections that are pivotally mounted with respect to each other.

It has been recognized that the tarp portion of the cover should be maintained in a taut configuration when the vehicle is moving to minimize degradation of the tarp portion caused by vibration from air moving across the tarp portion.

It has also been recognized that the cover system should be configured so that it is not necessary for the power to be maintained to the cover system after the cover system is placed in the closed configuration.

One way that has been suggested to maintain the tarp portion in the taut configuration is to use an electrically actuated brake in conjunction with the motor, which is discussed in Searfoss, U.S. Pat. No. 5,829,819. The brake and the motor are connected to a power source so that the power source maintains the brake in a disengaged configuration when power is applied to the motor. When the power source is turned off, the motor stops rotating and the brake moves to the engaged position. However, the brake in the Searfoss system is complicated, has moving parts that wear out because they physically engage each other, and needs electricity to work. The tarp system will be stuck in a closed or open position if power is unintentionally disrupted to the Searfoss system. When this happens, the tarp will not be able to be manually opened or closed.

### SUMMARY OF THE INVENTION

An embodiment of the invention that does not suffer from the problems of the prior art is directed to a magnetic braking motor system including a motor and a magnetic brake assembly. The motor includes a motor enclosure and a motor shaft rotatably mounted with respect to the motor enclosure. The magnetic brake assembly includes a rotating magnetic element and a stationary magnetic element. The rotating magnetic element is mounted with respect to the motor shaft. The stationary magnetic element is mounted with respect to the motor enclosure. A magnetic field is provided between the rotating magnetic element and the stationary magnetic element.

Another embodiment of the invention is directed to a motorized cover system for a vehicle having an upwardly directed opening. The motorized cover system includes a cover material, a cover material shaft, a motor and a magnetic brake assembly. The cover material is capable of covering at least a portion of the upwardly directed opening. The cover material shaft is operably attached to the cover material. The cover material is rolled onto the cover material shaft when moving from an extended configuration to a retracted configuration.

The motor includes a motor enclosure and a motor shaft. The motor shaft is rotatably mounted with respect to the motor enclosure. The motor shaft is operably attached to the cover material shaft. The magnetic brake assembly includes a rotating magnetic element and a stationary magnetic element. The rotating magnetic element is mounted with respect to the motor shaft. The stationary magnetic element is mounted with respect to the motor enclosure. A magnetic field is provided between the rotating magnetic element and the stationary magnetic element.

Another embodiment of the invention is directed to a method of using a magnetic brake. A motor is provided that includes a motor enclosure in which a motor shaft is rotatably mounted. The motor shaft is prevented from rotating with respect to the motor enclosure with a magnetic brake assembly. The magnetic brake assembly includes a rotating magnetic element and a stationary magnetic element. The rotating magnetic element is mounted with respect to the motor shaft. The stationary magnetic element is mounted with respect to the motor enclosure. A magnetic field is provided between the rotating magnetic element and the stationary magnetic element.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a prior art tarping system motor assembly.

FIG. 2 is a side view of an armature for use in a motor assembly on which a rotating portion of the magnetic brake assembly is mounted.

FIG. 3 is a perspective view of a first end of a motor assembly containing the magnetic brake of the embodiment illustrated in FIG. 2.

FIG. 4 is an end view of a motor enclosure for the motor assembly in which a stationary portion of the magnetic brake assembly is mounted.

FIG. 5 is an end view of the armature inside the motor enclosure of the embodiment illustrated in FIG. 2.

FIG. 6 is a side view of an assembled motor assembly of the embodiment illustrated in FIG. 2.

FIG. 7 is a magnetic field diagram of the end view of the motor assembly of the embodiment illustrated in FIG. 2.

FIG. 8 is a side view of a rotating magnetic element for an alternative embodiment of the magnetic brake.

FIG. 9 is a top view of the rotating magnetic element of FIG. 8.

FIG. 10 is an end view of the rotating magnetic element of FIG. 8.

FIG. 11 is an end view of a stationary magnetic element for use in conjunction with the rotating magnetic element of FIG. 8.

### DETAILED DESCRIPTION OF THE PREFERRED EMBODIMENTS

An embodiment of the invention is directed to a magnetic brake system for a motor such as is illustrated in the figures. In certain embodiments, the magnetic brake system is used in conjunction with an electric motor that is operably connected to a shaft that is used for rolling and unrolling the cover material that is used to cover a vehicle having an upwardly directed opening such as a trailer.

As discussed above, it is desirable for the cover material to be maintained in a taut configuration when the cover material is in a closed configuration. Maintaining the cover material in the taut configuration minimizes degradation of the cover material that is caused by wind blowing over the surface of the cover material as the vehicle on which the cover system is mounted moves. Similarly, maintaining the cover material taut when in an open configuration minimizes the potential of degradation to the cover material.

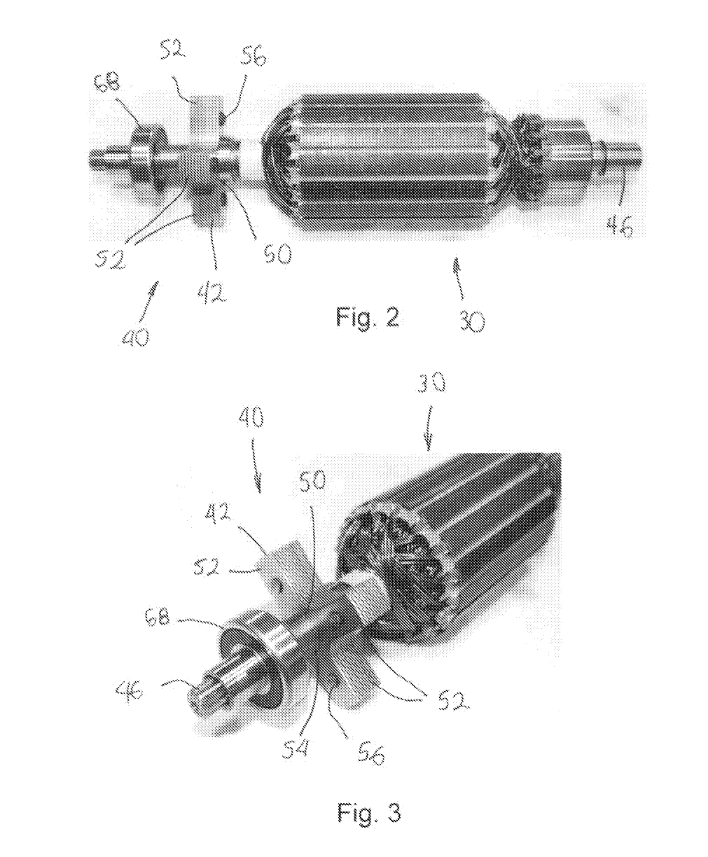

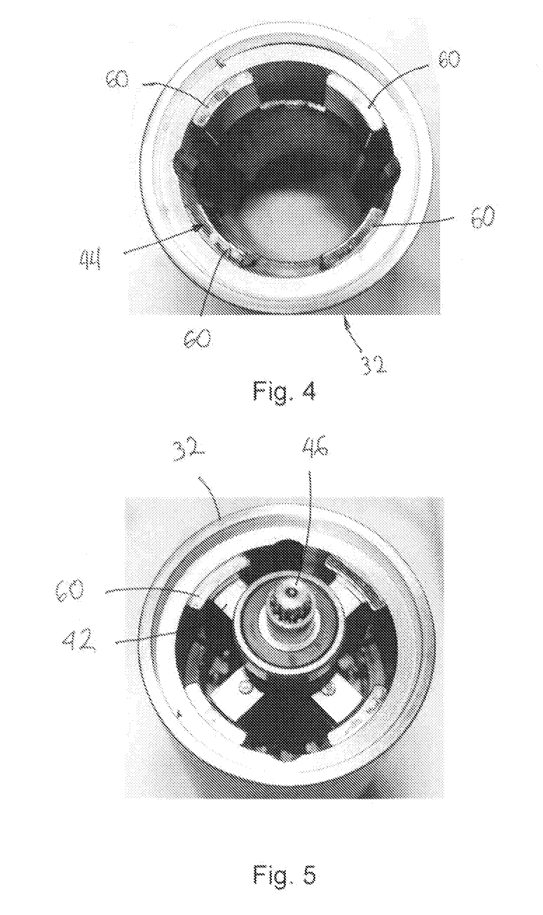

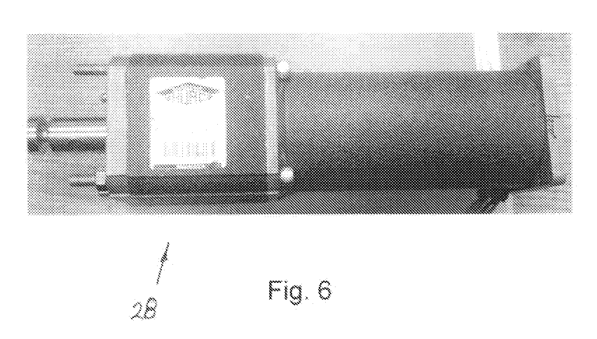

The electric motor 28 (FIG. 6) may have an armature or rotor (illustrated at 30 in FIGS. 2-3) that is rotatably mounted within a motor enclosure or stator (illustrated at 32 in FIG. 4), as illustrated in FIG. 5.

When electric current is provided to the electric motor 28, the armature 30 is caused to rotate with respect to the motor enclosure 32. When electric current is not provided to the electric motor 28, the armature 30 may be rotatable with respect to the motor enclosure 32.

While the discussion provided herein has been done with respect to an electric motor that is used in conjunction with a rolling cover system for an open top vehicle, a person of skill in the art will appreciate that the magnetic brake system may be used in conjunction with other types of motors as well as other types of devices having rotatable shafts where it is desired to selectively prevent the rotatable shaft from rotating. It is also possible to use the concepts of the invention in conjunction with products other than a rolling cover system.

The magnetic brake system 40 utilizes a magnetic force that is sufficiently strong to prevent rotation of the armature 30 when electric current is not applied to the electric motor 28. However, the magnetic strength of the magnetic brake system 40 is less than the force generated by the electric motor 28 when electric current is applied to the electric motor 28 such that the electric motor 28 may operate in substantially the same manner as an electric motor that does not have the magnetic brake system 40 attached thereto.

The magnetic brake system 40 may include two components. A rotating magnetic element 42 is mounted to the armature shaft 46, as illustrated in FIGS. 2-3. A stationary magnetic element 44 is mounted with respect to the motor enclosure 32.

In one configuration, the rotating magnetic element 42 has a magnetic element hub 50 and a plurality of magnetic element legs 52 that extend from the magnetic element hub 50. The magnetic element hub 50 may have an aperture 54 through which the armature shaft 46 extends.

The aperture 54 may be formed with a diameter that is similar to an outer diameter of the armature shaft 46 so that the rotating magnetic element 42 may snugly engage the armature shaft 46.

The rotating magnetic element 42 may be attached to the armature shaft 46 to prevent the rotating magnetic element 42 from rotating and/or sliding with respect to the armature shaft 46. A non-limiting example of a suitable mechanism for attaching the rotating magnetic element 42 to the shaft is a mechanical fastener (not shown) such as a screw that engages both the rotating magnetic element 42 and the armature shaft 46.

The plurality of magnetic element legs 52 extends radially from the magnetic element hub 50 so that a distal end of the magnetic element legs 52 is proximate the stationary magnetic element 44, as is discussed in more detail herein.

The number of magnetic element legs 52 utilized in the rotating magnetic element 42 may be selected based upon a variety of factors. An example of the factors is the amount of force that needs to be generated to prevent the armature 30 from rotating with respect to the motor enclosure 32 when power is not applied to the electric motor.

In one embodiment, there are four magnetic element legs 52. Each of the magnetic element legs 52 may be formed with a substantially similar size and shape. The magnetic element legs 52 may be positioned in a spaced-apart orientation around the magnetic element hub 50. In one such configuration, the spacing between the adjacent magnetic element legs 52 is approximately equal.

The magnetic element legs 52 are formed with a width and a thickness that enables a sufficiently strong magnetic field to be provided to prevent the armature 30 from rotating with respect to the motor enclosure 32 when power is not applied to the electric motor 28.

On the other hand, the magnetic element legs 52 may be formed with a relatively narrow width so that the magnets may be operable over a relatively small rotational arc, which is beneficial for minimizing the effect on the operation of the electric motor 28 when electric current is applied to the electric motor 28. In one such embodiment, the width and the thickness of the magnetic element legs 52 are both between about ½ of an inch and about 2 inches.

While it is possible to form the rotating magnetic element 42 from a unitary piece of material, in certain embodiments, the rotating magnetic element 42 is fabricated from a plurality of pieces. Each of the pieces may have a thickness that is a fraction of a desired thickness of the rotating magnetic element 42. The pieces may each have a similar shape and/or size.

For example, the rotating magnetic element 42 may be fabricated from between about 5 and 10 individual pieces. The individual pieces may be attached together using at least one fastener 56. In certain embodiments, one of the fasteners 56 is used on each of the magnetic element legs 52.

At least a portion of the rotating magnetic element 42 may be fabricated from a material that may be affected by the magnetic field generated by the stationary magnetic element 44. In one such embodiment, the rotating magnetic element 42 is fabricated from a ferrous metal material.

Even though there may be limited room within the motor enclosure 32, the magnetic braking assembly 40 may be located in a spaced-apart configuration with respect to the armature windings to minimize the potential effect on the operation of the motor caused by the magnetic field generated by the magnetic braking assembly 40.

In one such configuration, a distance between an end of the armature windings and the rotating magnetic element 42 may be at least ½ of an inch. In another configuration, the distance between the end of the armature windings and the rotating magnetic element 42 may be between about 1 inch and 2 inches.

The stationary magnetic element 44 includes a plurality of magnets 60 that are mounted with respect to the motor enclosure 32. In one such configuration, the magnets 60 are mounted on an inner surface of the motor enclosure 32.

The number of magnets 60 utilized may be equal to the number of magnetic element legs 52. In such a configuration, the magnets 60 may be mounted on the motor enclosure 32 in a position that corresponds to the location of the magnetic element legs 52 such that when electric current is not applied to the electric motor 28, the magnetic field causes the armature 30 to rotate to a position where the distal end of each magnetic element leg 52 is adjacent to one of the magnets 60.

A variety of materials may be used to fabricate the magnets 60. These materials may have various magnetic field strengths. One suitable type of magnet is a rare earth permanent magnet. In certain embodiments, the magnet is a neodymium magnet. Ceramic magnets may also be used.

A factor that may affect the selection of the material for the magnet is the anticipated operating temperatures for the magnetic brake system so that the magnets are not exposed to temperatures that could decrease the magnet field provided by the magnets.

An advantage of the rare earth magnets is that they exhibit a relatively strong magnetic field. In certain embodiments, the magnet has a magnetic flux density of at least about 15,000,000 Guass. In another embodiment, the neodymium magnet has a magnetic flux density of about 35,000,000 Gauss.

In certain embodiments, the rare earth magnets may have a length of about 1 inch and a thickness of about 0.185 inches. Each of the rare earth magnets may be configured to extend over a portion of the inner surface of the motor enclosure 32.

The amount of the surface area of the motor enclosure that is covered by the magnets may be affected by factors such as the field strength generated by the magnets and the amount of braking force needed to ensure that the motor shaft does not rotate when power is not applied to the motor.

In certain embodiments, each of the magnets may extend over about 45 degrees of the inner surface of the motor enclosure 32. As such, when four magnets are used in conjunction with the magnetic braking system 40, the magnets cover about half of the inner surface of the motor enclosure 32.

Using magnets 60 with a relatively strong magnetic field enable smaller magnets to be used. A benefit of such a configuration is that the magnets 60 may be operable over a relatively small rotational arc, which is beneficial for minimizing the effect on the operation of the electric motor 28 when electric current is applied to the motor.

While it is described above that the magnets 60 used in conjunction with the magnetic braking assembly 40 are permanent magnets, it is possible to use other types of magnets.

The magnets 60 should be formed with a sufficiently strong magnetic field to prevent the armature 30 from rotating with respect to the motor enclosure 32 when electric current is not applied to the motor. In one such configuration, the total force generated by the magnets may be about 25 inch-pounds.

The magnets are attached to the motor enclosure 32 using a technique that resists movement of the magnets with respect to the motor enclosure 32 under the conditions in which the motor experiences during typical operation. In one such configuration, a chemical adhesive is used to bond the magnets to the motor enclosure 32.

Physical contact between the rotating magnetic element 42 and the stationary magnetic element 44 is avoided by providing an air gap 58 between the distal ends of the magnetic element legs 52 and an inner surface of the stationary magnetic element 44.

On the other hand, the air gap 58 between the distal ends of the magnetic element legs 52 and the inner surface of the stationary magnetic element 44 should be relatively small to maximize the magnetic interaction between the rotating magnetic element 42 and the stationary magnetic element 44.

In certain embodiments, the air gap 58 may be between about 0.001 inches and about 0.10 inches. In other embodiments, the air gap 58 may be about 0.030 inches. A person of skill in the art will appreciate that the air gap 58 may be affected by manufacturing tolerances of the rotating magnetic element 42, the stationary magnetic element 44 as well as the other components utilized in the magnetic braking assembly 40 and the motor.

Because of the cylindrical nature of the magnetic braking assembly 40, the distal ends of the magnetic element legs 52 may be formed with a convex surface having a curvature so that a distance between the shaft and the distal end is approximately equal over a substantial portion of the distal end.

Similarly, the inner surface of the stationary magnetic element 44 may be formed with a concave surface having a curvature so that a distance between the shaft and the inner surface is approximately equal over a substantial portion of the inner surface.

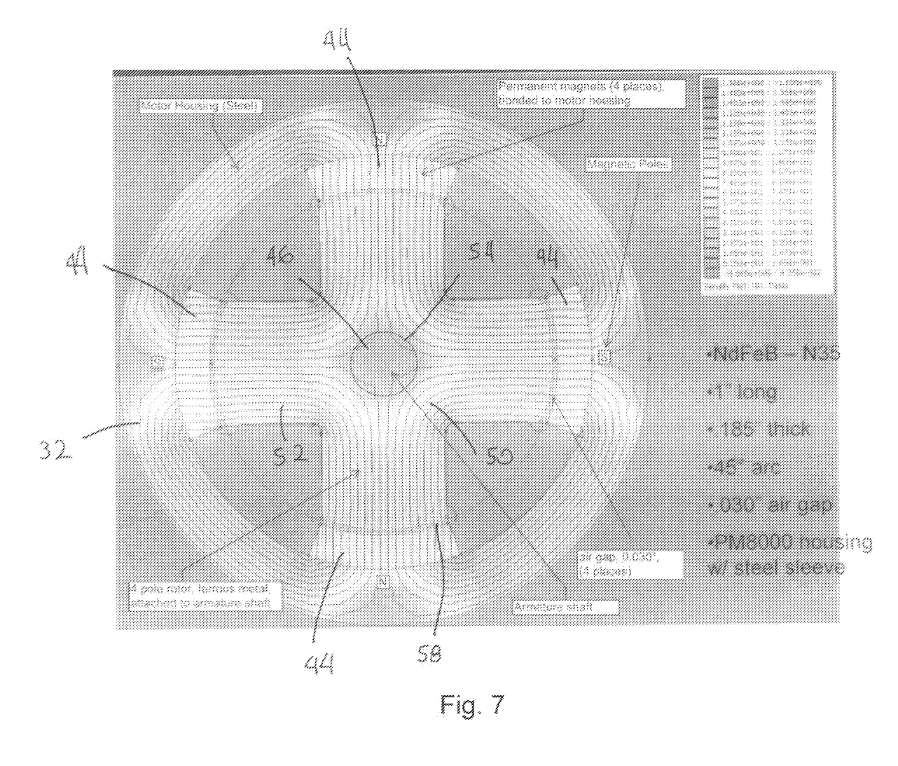

The magnets may be configured so that north magnetic poles are located proximate upper and lower ends of the magnetic braking assembly 40, as illustrated in FIG. 7. In such a configuration, south magnetic poles may be located proximate right and left sides of the magnetic braking assembly 40 approximately intermediate the north magnetic poles.

As illustrated in FIG. 7, the magnetic field lines extend outwardly from the armature shaft through the magnetic element legs towards the magnets. The magnetic field lines then extend through the motor enclosure before passing through an adjacent magnetic element leg towards the armature shaft. It is noted that this configuration provides a relatively strong magnetic field strength through the magnetic braking assembly 40 to maximize the braking capacity.

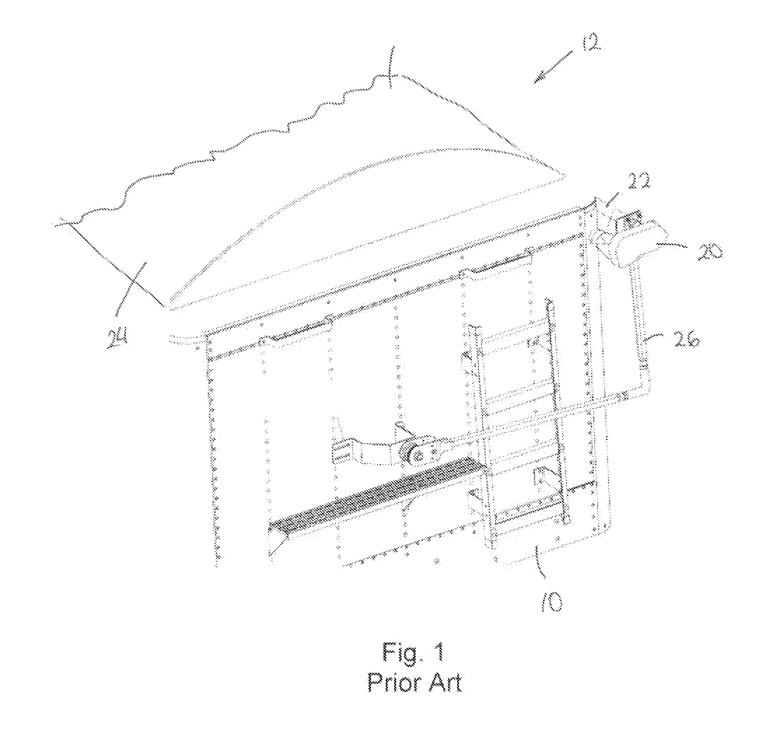

The motor armature 46 may be connected to a torque multiplying mechanism (such as indicated by reference number 20 in FIG. 1). In certain embodiments, the torque multiplying mechanism may be a gearbox that includes a plurality of gears that are in a planetary configuration. This configuration enables the gearbox to be attached to an end of the motor where the output shaft is located and have dimensions that are similar to the dimensions of the motor.

When the torque multiplying mechanism is a gearbox, the gears in the gearbox provide a different rotational rate for the motor shaft and the cover shaft. In many situations, this configuration increases a torque that is provided by the motor. The increase in torque may be affected by the gear ratio. In certain embodiments the torque multiplying ratio provided by the torque multiplying mechanism is between about 50:1 and about 250:1. In other embodiments, the torque multiplying ratio provided by the torque multiplying mechanism is about 120:1.

Because of the interaction of the components within the torque multiplying mechanism, the torque multiplying mechanism may result in a decrease in the efficiency of the system. This decrease in efficiency may result from a variety of factors such as the gear ratio and the number of gears included in the gearbox. In certain embodiments, the torque multiplying mechanism may have an efficiency of between about 60 percent and about 90 percent. In other embodiments, the torque multiplying mechanism may have an efficiency of about 75 percent.

The decrease in efficiency not only affects the torque provided by the motor to the shaft over which the cover is wound but also affects the ability for the cover shaft to rotate when the motor is turned off. For example, when the torque multiplying mechanism has an efficiency of about 75 percent, there is a reduction of torque provided to the cover shaft of about 25 percent.

On the other hand, the efficiency also affects the braking ability of the magnetic brake system by decreasing the torque that is transferred from the cover shaft through the torque multiplying mechanism and to the magnetic brake system when the cover shaft is back-driven such as when the motor is turned off. This configuration thereby enables the strength of the magnetic brake system to be lower than if the torque multiplying mechanism had a higher efficiency.

When the torque multiplying mechanism has a ratio of about 120:1, this configuration may produce a holding torque of about 250 foot-pounds, when trying to back-drive the output shaft of the torque multiplying mechanism. This force is sufficiently high to prevent the armature 30 from rotating with respect to the motor enclosure 32 when electric current is not applied to the electric motor 28 but is less than the force generated by the motor when the electric current is applied to the electric motor 28.

In certain embodiments, the force generated by the electric motor 28 when electric current is applied thereto is about 35 inch-pounds. This configuration enables the electric motor 28 to start and run similar to an electric motor that does not have a magnetic braking assembly 40.

To enhance the ability of the armature 30 to rotate smoothly in spite of the forces applied by the magnetic braking assembly 40, a bearing assembly 62 may be provided on at least one side of the rotating magnetic element 42. In one such configuration, the bearing assembly 62 may be provided proximate to a side of the rotating magnetic element 40 that is opposite the armature 30.

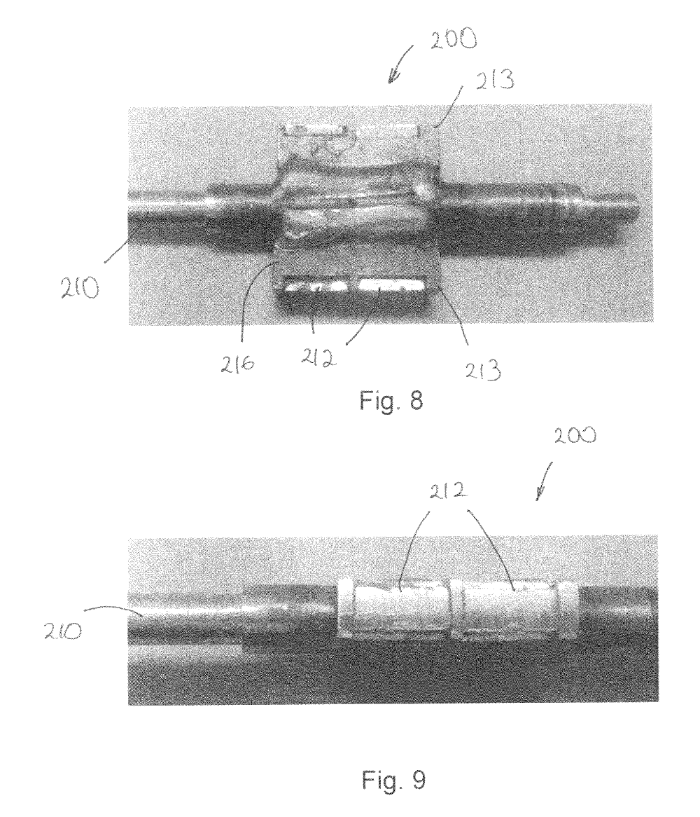

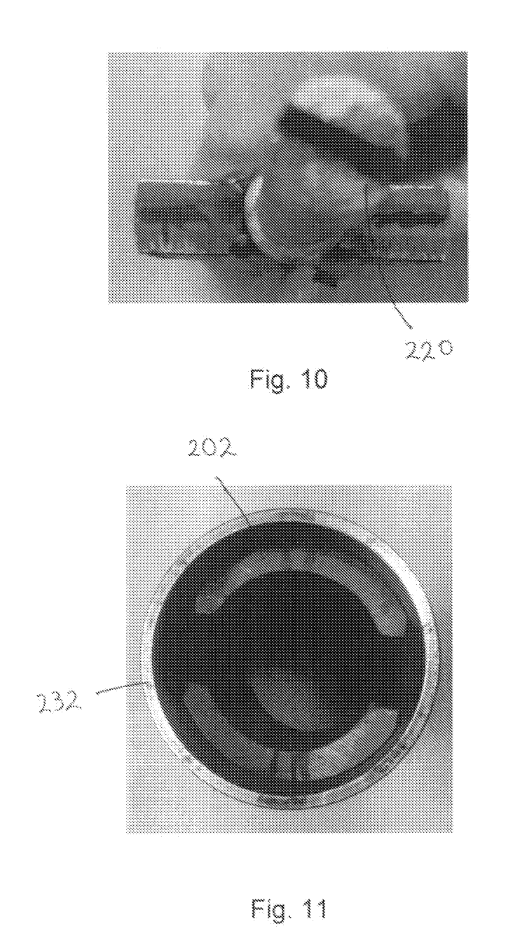

In another embodiment, the magnetic brake system may generally include a rotating magnetic element 200 such as is illustrated in FIGS. 8-10 and a stationary magnetic element 202 such as is illustrated in FIG. 11. The rotating magnetic element 200 may generally include a shaft 210 and a rotating magnet 212. This embodiment utilizes two magnetic element legs 213 in the rotating magnet 212, instead of four in the earlier discussed embodiment, and two stationary magnets 202, again as compared with four in the earlier embodiment.

The shaft 210 may be substantially cylindrical and may be formed with a diameter that is approximately the same as a diameter of a shaft in the armature. The shaft 210 may thereby have a strength that is at least approximately the same as a strength of the armature shaft.

The shaft 210 may include a first connector 220 proximate a first end thereof that is adapted to engage an end of the armature shaft. The first connector 220 thereby causes the shaft 210 to be fixedly mounted to the armature shaft such that the shaft 210 rotates when the armature shaft rotates. In other embodiments, the shaft 210 is attached to and extends from the armature shaft.

The shaft 210 may include a second connector proximate a second end thereof. The second connector (not shown) may facilitate attachment of the electric motor to the other portions of the rolling cover system. In other embodiments, the magnetic brake system may be attached to an end of the electric motor that is opposite the end that is attached to the other portions of the rolling cover system. The magnetic brake system may also be mounted on the armature shaft and located inside the motor housing.

The rotating magnet 212 is attached to the shaft 210 in such a manner that the rotating magnet 212 is sufficiently close to the stationary magnet element 202 to generate a desired level of magnetic attraction and repulsion. A person of skill in the art will appreciate that the spacing may depend on a variety of factors such as the size of the rotating magnet 212 and the field strength generated by the magnet.

In certain embodiments, a spacer 216 is provided between the shaft 210 and the rotating magnet 212 so that the rotating magnet 212 is sufficiently close to the stationary magnet element 202, as illustrated in FIG. 8. The spacer 216 may be composed of a ferrous metal material and may contribute to shaping the magnetic field of magnet 212. Alternately, the spacer 216 may not be required and magnet 212 may mount directly to shaft 210.

There may be more than one rotating magnet 212 mounted to the shaft 210. In certain embodiments, there may be two rotating magnets 212 mounted with respect to the shaft 210 as illustrated in the figures. The number of rotating magnets 212 utilized may affect the strength of the magnetic field. As such, a greater magnetic field may be provided by utilizing a greater number of rotating magnets 212.

The rotating magnets 212 may include two magnet components that are mounted to the shaft 210 in an opposed configuration so that they are located on opposite sides of the shaft 210, as illustrated in FIG. 8. In such a configuration, the magnet components may be generally aligned with each other.

In certain embodiments, the rotating magnets 212 on a first side of the shaft 210 may be oriented with a north pole facing away from the shaft 210 and the rotating magnets 212 on a second side of the shaft 210 may be oriented with a north pole facing toward the shaft 210.

The stationary magnet element 202 may include at least two stationary magnet components that are similar to the two rotating magnet components. Using such a configuration provides a balanced magnetic field. A non-balanced magnetic field may place forces on the electric motor during the rotation.

The non-balanced magnetic field may also place forces on other components that are attached to the electric motor. These forces could lead to premature degradation of the electric motor and the components attached thereto. The two stationary magnets for the brake assembly may be the same magnets mounted within motor enclosure 232 that are used to provide armature rotation.

While it is described herein that the magnetic brake assembly is attached to the motor, it is possible for the magnetic brake assembly to be utilized in other configurations. An example of one such alternative configuration is incorporating the magnetic brake assembly into the torque multiplying mechanism.

At least a portion of the torque multiplying mechanism may be fabricated from a metallic material. Alternatively, a metallic material may be attached to the gear. Magnets may be mounted with respect to an enclosure of the torque multiplying mechanism. Such a configuration would be similar to the configuration described and illustrated above. It is also possible for the positions of the metallic material and the magnets to be reversed so that the magnets are attached to the gear and the metallic material is mounted with respect to the enclosure of the torque multiplying mechanism.

The magnetic brake system is also suited for use in conjunction with motors used on other portions of a vehicle where it is desirable to prevent the motor from rotating when the motor is not turned on. Examples of other components on a vehicle on which the magnetic brake system may be used in conjunction with a motor include trap doors and landing gear.

There are also applications for the magnetic brake system to be used with motors on objects other than vehicles where it is desirable to prevent the motor from rotating when the motor is not turned on. An example of one such application is an electric gate or door system in which a motor is used to move the gate between open and closed positions.

In addition to the use of the magnetic brake system in conjunction with a motor, it is possible to use the magnetic brake system with components that are manually operable. A few examples of such components are a manually operated rolling cover system for an open top vehicle such as a grain hauling trailer and a manually operated landing gear on a trailer.

These manually operated rolling cover systems utilize an elongated crank arm that is rotated by an operator to cause the cover system to move between open and closed configurations. Typically a latch is utilized to hold the crank arm in a stationary position with respect to the vehicle and thereby prevent the cover system from inadvertently moving from the open or closed configuration.

The magnetic brake system may be operably attached to the rolling cover system such as to the cover shaft to thereby prevent inadvertent movement of the cover system from the open or closed configuration. Such a configuration may enable the crank arm to be used without the latch or this configuration may enable the crank arm to be disconnected after the rolling cover system is moved to the open configuration or the closed configuration.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims. The contents of the patents referenced herein are incorporated herein by reference.

It is contemplated that features disclosed in this application, as well as those described in the above applications incorporated by reference, can be mixed and matched to suit particular circumstances. Various other modifications and changes will be apparent to those of ordinary skill.

1. A magnetic braking motor system comprising:
a motor comprising:
a motor enclosure; and
a motor shaft rotatably mounted with respect to the motor enclosure; and
a magnetic brake assembly comprising:
a rotating magnetic element mounted with respect to the motor shaft; and
a stationary magnetic element mounted with respect to the motor enclosure, wherein a magnetic field is provided between the rotating magnetic element and the stationary magnetic element.

2. The magnetic braking motor system of claim 1, wherein the motor has a rotational strength when the motor is turned on and wherein the motor rotational strength is larger than a strength of the magnetic field.

3. The magnetic braking motor system of claim 1, wherein at least one of the rotating magnetic element and the stationary magnetic element comprises at least one magnet portion.

4. The magnetic braking motor system of claim 3, wherein the at least one magnet portion is a permanent magnet.

5. The magnetic braking motor system of claim 4, wherein the permanent magnet is a rare earth permanent magnet.

6. The magnetic braking motor system of claim 3, wherein magnet portions are mounted with respect to the motor enclosure in a spaced-apart configuration so that a spacing between adjacent magnet portions is approximately equal.

7. The magnetic braking motor system of claim 1, wherein at least a portion of the rotating magnetic element is fabricated from a ferrous material and at least a portion of the stationary magnetic element is a permanent magnet.

8. The magnetic braking motor system of claim 7, wherein the rotating magnetic element comprises a central region and at least one leg that extends from the central region and wherein a quantity of the at least one leg is equal to a quantity of the at least one magnet portion.

9. The magnetic braking motor system of claim 7, wherein the motor further comprises an armature mounted with respect motor shaft and wherein an interaction between the armature and the stationary magnetic element causes the motor shaft to rotate with respect to the motor enclosure.

10. The magnetic braking motor system of claim 7, wherein the rotating magnetic element is fabricated from a plurality of pieces and wherein each of the pieces have a similar shape.

11. The magnetic braking motor system of claim 7, wherein the rotating magnetic element completes a magnetic field in the stationary magnetic element and the motor enclosure.

12. The magnetic braking motor system of claim 1, wherein at least a portion of the rotating magnetic element is a permanent magnet and at least a portion of the stationary magnetic element is fabricated from a ferrous material.

13. The magnetic braking motor system of claim 12, wherein the rotating magnetic element comprises a central region and at least one leg that extends from the central region and wherein at least a portion of each leg is the permanent magnet.

14. The magnetic braking motor system of claim 1, wherein the magnetic brake assembly is separate from the motor.

15. The magnetic braking motor system of claim 1, and further comprising a torque multiplying mechanism operably attached to at least one of the motor and the magnetic brake assembly, wherein the torque multiplying mechanism has an input shaft and an output shaft and wherein a torque provided by the input shaft is different than a torque provided by the output shaft.

16. The magnetic braking motor system of claim 1, wherein the magnetic brake assembly functions as a slip clutch for the motor.

17. A magnetic braking motor system comprising:
a motor comprising:
a motor enclosure; and
a motor shaft rotatably mounted with respect to the motor enclosure;
a torque multiplying mechanism having an input shaft and an output shaft, wherein a torque provided by the input shaft is different than a torque provided by the output shaft; and
a magnetic brake assembly comprising:
a rotating magnetic element mounted with respect to the motor shaft and the input shaft; and
a stationary magnetic element mounted with respect to the motor enclosure, wherein a magnetic field is provided between the rotating magnetic element and the stationary magnetic element.

18. The magnetic braking motor system of claim 17, wherein the motor has a rotational strength when the motor is turned on and wherein the motor rotational strength is larger than a strength of the magnetic field.

19. The magnetic braking motor system of claim 17, wherein at least one of the rotating magnetic element and the stationary magnetic element comprises at least one magnet portion.

20. The magnetic braking motor system of claim 19, wherein the at least one magnet portion is a permanent magnet.

21. The magnetic braking motor system of claim 17, wherein at least a portion of the rotating magnetic element is fabricated from a ferrous material and at least a portion of the stationary magnetic element is a permanent magnet, wherein the rotating magnetic element comprises a central region and at least one leg that extends from the central region and wherein a quantity of the at least one leg is equal to a quantity of the at least one magnet portion.

22. The magnetic braking motor system of claim 17, wherein at least a portion of the rotating magnetic element is a permanent magnet and at least a portion of the stationary magnetic element is fabricated from a ferrous material and wherein the rotating magnetic element comprises a central region and at least one leg that extends from the central region and wherein at least a portion of each leg is the permanent magnet.

23. The magnetic braking motor system of claim 17, wherein the torque multiplying mechanism has a ratio of between about 50:1 and about 250:1.

24. A motorized cover system for a vehicle having an upwardly directed opening, wherein the motorized cover system comprises:
a cover material that is capable of covering at least a portion of the upwardly directed opening;
a cover material shaft operably attached to the cover material, wherein the cover material is rolled onto the cover material shaft when moving from an extended configuration to a retracted configuration;
a motor comprising:
a motor enclosure; and
a motor shaft rotatably mounted with respect to the motor enclosure, wherein the motor shaft is operably attached to the cover material shaft; and
a magnetic brake assembly comprising:
a rotating magnetic element mounted with respect to the motor shaft; and
a stationary magnetic element mounted with respect to the motor enclosure, wherein a magnetic field is provided between the rotating magnetic element and the stationary magnetic element.

25. The motorized cover system of claim 24, and further comprising an arm assembly that is operably attached the motor to the vehicle.

26. The motorized cover system of claim 24, wherein the motor has a rotational strength when the motor is turned on and wherein the motor rotational strength is larger than a strength of the magnetic field.

27. The motorized cover system of claim 24, wherein at least one of the rotating magnetic element and the stationary magnetic element comprises at least one magnet portion.

28. The motorized cover system of claim 27, wherein the at least one magnet portion is a permanent magnet.

29. The motorized cover system of claim 24, wherein at least a portion of the rotating magnetic element is fabricated from a ferrous material and at least a portion of the stationary magnetic element is a permanent magnet, wherein the rotating magnetic element comprises a central region and at least one leg that extends from the central region and wherein a quantity of the at least one leg is equal to a quantity of the at least one magnet portion.

30. The motorized cover system of claim 24, wherein at least a portion of the rotating magnetic element is a permanent magnet and at least a portion of the stationary magnetic element is fabricated from a ferrous material and wherein the rotating magnetic element comprises a central region and at least one leg that extends from the central region and wherein at least a portion of each leg is the permanent magnet.

31. The motorized cover system of claim 24, and further comprising a torque multiplying mechanism operably attached to at least one of the motor and the magnetic brake assembly, wherein the torque multiplying mechanism has an input shaft and an output shaft and wherein a torque provided by the input shaft is different than a torque provided by the output shaft.

32. A method of using a magnetic brake comprising:
providing a motor comprising a motor enclosure in which a motor shaft is rotatably mounted; and
preventing rotation of the motor shaft with respect to the motor enclosure with a magnetic brake assembly, wherein the magnetic brake assembly comprises a rotating magnetic element and a stationary magnetic element, wherein the rotating magnetic element is mounted with respect to the motor shaft, wherein the stationary magnetic element is mounted with respect to the motor enclosure and wherein a magnetic field is provided between the rotating magnetic element and the stationary magnetic element.

33. The method of claim 32, wherein the motor has a rotational strength when the motor is turned on and wherein the motor rotational strength is larger than a strength of the magnetic field.

34. The method of claim 32, wherein at least one of the rotating magnetic element and the stationary magnetic element comprises at least one magnet portion and wherein the at least one magnet portion is a permanent magnet.

35. The method of claim 34, and further comprising:
mounting the at least one magnet portion with respect to the motor enclosure;
forming the rotating magnetic element with a central region and at least one leg that extends from the central region; and
providing the at least one leg with a quantity is equal to a quantity of the at least one magnet portion.

36. The method of claim 34, and further comprising:
mounting the at least one magnet portion with respect to the motor shaft; and
fabricating at least a portion of the motor enclosure from a ferrous material.

37. The method of claim 32, and further comprising operably attaching a torque multiplying mechanism to at least one of the motor and the magnetic brake assembly, wherein the torque multiplying mechanism has an input shaft and an output shaft and wherein a torque provided by the input shaft is different than a torque provided by the output shaft.
